(19) United States
(12) Patent Application Publication
(10) Pub. No.: US 2026/0120559 A1
(43) Pub. Date: Apr. 30, 2026

(54) METHOD AND SYSTEM TO CONTROL THE WIRELESS NODE BY A VISIBLE LIGHT FLASH PATTERN RECOGNITION

(71) Applicant: Shenzhen Litetrace Technologies CO., Ltd., Guangdong (CN)

(72) Inventor: Ming DENG, Guangdong (CN)

(73) Assignee: Shenzhen Litetrace Technologies CO., Ltd., Guangdong (CN)

(21) Appl. No.: 19/059,171

(22) Filed: Feb. 20, 2025

(30) Foreign Application Priority Data
Oct. 29, 2024 (CN) 202411520307.4

(51) Int. Cl. G08C 23/04

(52) U.S. Cl. CPC G08C 23/04

(57) ABSTRACT

This invention is applicable to the field of the Internet of Things technology, and provides a method and a system to control the wireless node by a visible light flash pattern recognition, including:
S1. light-emitting device is used to flash and illuminate a photo sensor on the wireless device according to the preset frequency or coding way;
S2. the wireless device continuously reads the sample data from the photo sensor. Based on those sample data, decode the flash frequency or coding way of the light-emitting device;
S3. the wireless device enters different states or carries out the operations corresponding to the coding ways according to the result data gained by decoding.

By using the visible photo sensor of the current controllers to realize it, there is no need to add new components or receiving on the device, which efficiently reduces the cost and device complexity.

### CROSS-REFERENCE TO RELATED APPLICATION

This application claims the priority benefit of China patent application serial no. 202411520307.4, filed on Oct. 29, 2024. The entirety of the above-mentioned patent application is hereby incorporated by reference herein and made a part of this specification.

### BACKGROUND OF THE DISCLOSURE

### 1. Field of the Disclosure

This invention is related to the field of the Internet of Things technology, particularly related to the wireless signal enable, disable, mode switch and other technologies and products of wireless Internet of Things equipment, as well as their applications in the lighting control field, especially with respect to the control method and a system to control the wireless node based on a visible light flash pattern recognition.

### 2. Description of Related Art

The wireless Internet of Things device doesn't require physical line connection, and has the advantages of low implementation cost and reduced labor requirements. However, wireless connection technology also has some inherent problems, such as: difficult to determine the location of nodes, not easy to do an accurate one-to-one operation and settings to the nodes.

At present, there are some common methods in the market to solve those problems, such as: 1. add extra buttons on the wireless equipment, allowing the wireless device to enter a specific mode by clicking or pressing and holding on the buttons. 2. Install additional receiver on the wireless device, for example, laser receiving head, infrared receiving head etc. Transmit signals to the receivers on the wireless device by the corresponding transmitting devices, such as laser transmitter, infrared transmitter etc., to allow the device to enter a specific mode. 3. Allow the device to enter a specific mode by cycling power off and on. To avoid the mis-operation, usually set a power on and off cycle with multiple different durations. For example, power on shortly for consecutive three times, or long power on for consecutive three times plus shortly for consecutive twice etc. Above mentioned specific modes include but not limit to: a. wireless pairing mode, in which the wireless device can paired. b. Scene setting, to save the current device situation to a specific scene. c. Enable or disable the wireless function etc.

Above-mentioned setting methods also expose some defects in the practical application:

1. It is hard for personnel to access to the wireless device because sometimes they are installed at high or hidden locations. So, the method of clicking or pressing button is unpractical in many application scenarios.

2. Additional receiver will increase the complexity of the device design, hardware and production cost. Moreover, some special transmitting devices are required, which also brings lots of inconveniences in the practical applications.

3. Directivity and distance problems of transmitting signals, also result in the difficulty of field applications:

a. Some transmitted signals, such as laser etc., have a too narrow directivity. Only direct to a very narrow area, even a point. If the device is a little bit far away, it is very hard to accurately target the laser point to the device receiver.

b. Some transmitted signals, such as infrared etc., have a too wide directivity and are easy to be reflected. This results in that a receiver in a vast area can receive the command. It is hard to achieve a precise one-to-one control.

c. Some transmitted signals, such as infrared, a damping very fast, and have a short effective distance. Wireless device can't be controlled effectively in a further distance.

4. To operate by cycling power on and off, all devices on one power supply circuit are operated collectively, and it is impossible to control a single device individually. Furthermore, at the customer's site, one power supply circuit has a heavy load most of time so that it is hard to implement the operation of cycling the power on and off.

5. For the common operating ways, their modes are simple, usually only single operation can be accomplished. It is difficult to realize a diversified practical application demand of the wireless Internet of Things device.

The above defects limit a promotion of wireless Internet of Things technical solutions. There is an urgent demand for a more simple and convenient wireless device quick control solution.

### SUMMARY OF THE DISCLOSURE

A purpose of this invention is to provide a method to control wireless node by visible light flash pattern recognition, and aims to solve the above-mentioned technical problems.

The invention is achieved in such a way to control wireless node by visible light flash pattern recognition. This control method includes following steps:
S1. light-emitting device is used to flash and illuminate the photo sensor on the wireless device according to the preset frequency or coding way;
S2. The wireless device continuously reads the sample data from photo sensor. Based on those sample data, decode the flash frequency or coding way of the light-emitting device;
S3. The wireless device enters different states or carries out the operations corresponding to the coding ways according to the result data gained by decoding.

This invention's further technical solution is: the step S2 further comprises the following steps:
S21. The wireless equipment continuously reads the photo sensor readouts after power on;
S22. According to the photo sensor readout variations, calculate an artificial visible light flash frequency and output it to the follow-up recognition process flow.

This invention's further technical solution is: in step S21, analyze a proportional change of photo sensor readouts or the absolute value change exceeding to a certain threshold to determine whether it is artificial visible light flash. If it is, then carry out step S22. If not, return to step S21.

This invention's further technical solution is: the step S3 consists of following steps: S31. The wireless device is powered on to initialize the pattern recognition state machine and continuously reads out the flash frequency currently read by the light sensing;

S32. Determine whether it is an artificial visible light flash. If it is, calculate the frequency and time and update the pattern recognition state machine, then return to the step S31. If not, match the corresponding pattern in accordance with the state machine's condition and carry out the next step;

S33. Determine whether the state machine matches any preset patten. If yes, carry out the operations corresponding to this pattern or enters the corresponding state. If not, reset to the pattern recognition state machine and return to the step S31.

This invention's further technical solution is: in the step S32, in case of detecting the artificial visible light flash frequency, determine whether the flash frequency is the same as the previous while calculating the flash duration of this frequency. If it is, update this frequency flash duration, and update the state of this state machine based on this; if not, update the state of this state machine and record a new flash frequency and duration.

This invention's further technical solution is: in the step S1 the preset frequency or coding way includes continued frequency flash or combination frequency flash or as those similar to barcodes, morse code; when the said frequency continuously flashes or the combination frequency flashes, duration can be assigned to each frequency.

This invention's further technical solution is: in the step S3 different states or operations corresponding to the coding ways include enabling or disabling the wireless signal of the device, or add the device to a group or delete it from a group, or set the current state to a scene or remove a scene or multiple scenes.

Another purpose of this invention is to provide a system to control wireless node based on visible light flash pattern recognition. This control system includes:
Visible light illuminating controller, used to flash and illuminate the photo sensor on the wireless device by making use of light-emitting devices according to the preset frequency or coding way; Sampling and decoding processor, used for wireless device continuously reading the sample data from photo sensor, and decoding the flash frequency or coding way of the light-emitting devices based on those sampling data;
State operation processor, used for wireless device entering different states or carrying out the operations corresponding to the coding ways based on the result data gained from decoding.

This invention's further technical solution is: the sampling and decoding module as stated also consists of:
Photo sensor reader, used for wireless equipment continuously reading the Photo sensor readouts after power on;
Calculation output controller, used to calculate the artificial visible light flash frequency according to the photo sensor readout variations and output to the follow-up recognition process flow.

This invention's further technical solution is: by analyzing the photo sensor readout proportion change or the absolute value exceeding to a certain threshold in the photo sensor reader as stated, determine whether it is the artificial visible light flash. If it is, carry out the calculation output processor; if not, return to the photo sensor reader;

The state operation module as stated includes: Reading and recognition processor, used for wireless device initializing the pattern recognition state machine and continuously reading the flash frequency recognized currently after power on; Visible light recognition processor, used to determine whether the artificial visible light flash is detected. If it is, calculate the frequency and time, update the pattern recognition state machine and return to reading and recognition unit. If not, match the corresponding patterns according to the state of the current state machine and carry out the state machine determining unit;

State machine determining processor, used to determine whether state machine matches a pattern. If it is, the current state machine matches a preset flash pattern, and carry out the operation corresponding to the matched pattern. If not, reset to the pattern recognition state machine and return to the reading and recognition unit;

In case of detecting the artificial visible light flash frequency in the visible light recognition unit as stated, determine whether the flash frequency is the same as the previous while calculating the flash duration of this frequency. If it is, update this frequency flash duration, and update the state of this state machine based on this; if not, update the state of this state machine and record a new flash frequency and duration; In the visible illuminating processor as stated, the preset frequency or coding way includes continued frequency flash or combination frequency flash or those similar to barcodes, morse code; when the said frequency continuously flashes or the combination frequency flashes, duration can be assigned to each frequency.

In the state operation processor as stated, different states or operations corresponding to the coding ways include enabling or disabling the wireless signal of the device, or add the device to a group or delete it from a group, or set the current state to a scene or remove a scene or multiple scenes.

The beneficial effect of this invention is: by using the visible photo sensor of the current controllers to realize it, there is no need to newly add special sensor or receiving on the device, which efficiently reduces the cost and device complexity.

Frequency pattern recognition with visible light can use the common flashlight, searchlight, and head lamp to operate. Those lamps may already have the flash mode, and can be used directly; also, can be easily modified to achieve a flash of the designated mode. It's simple, convenient, and feasible.

For light-emitting devices, it is easy to find, design, and manufacture the product with different powers, different focus or zoomable. It can conveniently meet a demand of different applications, and control light spot range to achieve a precise one-to-one control conveniently.

The common products in the market usually only carries out one single simple operation. This solution can achieve the multiple control demands by means of frequency flash pattern recognition without increasing the cost. This is more flexible and convenient.

The control is achieved through remote control without the actual contact, which is more flexible in the actual site application.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a general flow chart of assistant control by flashlight provided by the embodiment of this invention.

FIG. 2 is a wireless device light sensing frequency recognition flow chart provided by the embodiment of this invention.

FIG. 3 is a pattern recognition process operation flow chart provided by the embodiment of this invention.

FIG. 4 is an external view of the front and back Bluetooth intelligent lighting controller provided by the embodiment of this invention.

FIG. 5 is the front and back views of the Bluetooth lamp controller PCBA provided by the embodiment of this invention.

FIG. 6 is a diagram of a flashlight with adjustable focus and flash function provided by the embodiment of this invention.

FIG. 7 is an intelligent lamp installed with Bluetooth lamp controller provided by the embodiment of this invention.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

123 The embodiments of this invention are described in detail as below, which examples are shown in the figures. Where the same or similar symbols always represent the same or similar elements or those with same or similar functions. The embodiments described below with reference to those figures are exemplary, aiming to explain this invention rather than to understand it as a restriction to this invention.

In the description of this invention, it is understood that orientation or position relationship indicated by terms “length”, “width”, “up”, “down”, “front”, “back”, “left”, “right”, “vertical”, “horizontal”, “top”, “bottom”, “inside”, and “outside” are based on the orientation or position relationship as shown in the figures. They are only to conveniently describe this invention and simplify those descriptions, and do not indicate or imply that the device or element as shown must have a specific orientation, be constructed and operated at this specific orientation. Therefore, do not understand it as a restriction to this invention. In addition, in the description of this invention, “multiple” means two or more than two, unless otherwise specified with a specific limit.

A corresponding solution for this application is to solve the defects of existing technology. Requirements and objectives of this solution include: no need to add additional components on the wireless equipment, and achievement of this solution by the existing components on the wireless equipment itself. This solution should be operated easily and conveniently, and no physical actual contact is required, which can meet a control distance requirement for general application scenes, can conveniently achieve the one-to-one control, and can achieve multiple simple control functions, operating the device to enter different states or implement simple operations. It is not the full-featured device operation and configuration that are still to be achieved via gateway, special software, APP, programmer etc.

For the requirements and objectives of this solution, and the specific and permeability of wireless Internet of Things application, this invention patent is designed and developed for wireless intelligent lighting controller. Particularly, this solution is applicable to the wireless intelligent device with photo (visible light) sensor. In the wireless intelligent lighting controller, there is usually a built-in photo sensor for daylight harvesting and energy saving controls. This applied technical solution is to use photo sensor to achieve a simple, convenient, quick control function.

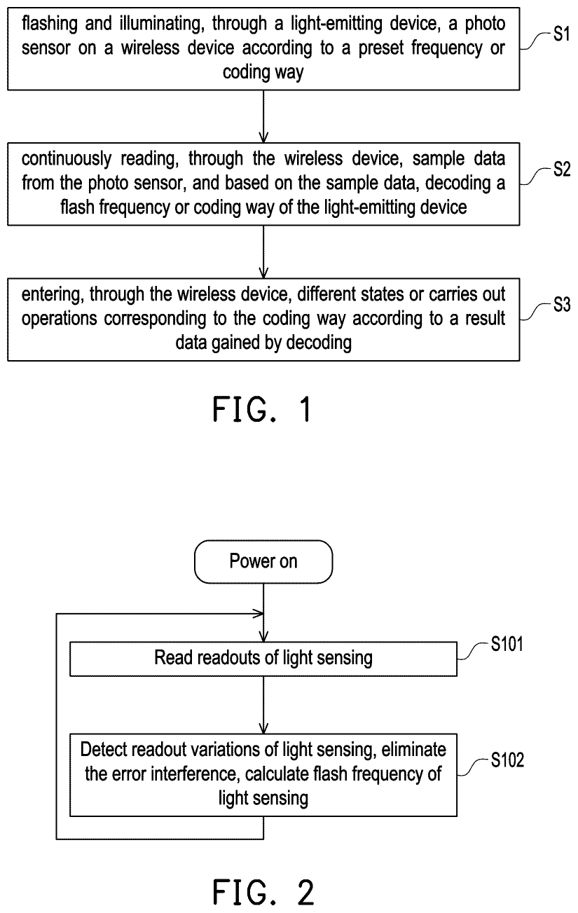

As shown in FIG. 1, the control method to achieve the wireless node based on visible light flash pattern recognition provided by this invention is described in detail as below:

Step S1: A light-emitting device is used to flash and illuminate the light sensor on the wireless equipment according to the preset frequency or coding way; illuminate the light sensors on the wireless equipment by flashlight and other luminaires. Flashlight is only for reference. In the practical use searchlight, flash lamp, head lamp and other visible light-emitting devices can be used. Flashlight and other light-emitting devices flash according to the preset frequency or coding way.

Step S2: The wireless device continuously reads the sample data from photo sensor. Based on those sample data, decode the flash frequency or coding way of the light-emitting devices; wireless device continuously reads the sample data from photo sensor, decodes the flash frequency or code of light-emitting devices. Flash frequency or code of light-emitting devices includes but not limits to following types: flash continuously according to the designated frequency, for example, flash at 0.5 hz, 1 hz, 3 hz, and 5 hz frequencies. Flash according to the frequency combinations, such as 0.5 hz+3 hz, 1 hz+5 hz, etc. In the way of similar barcode and morse code, flash by means of a long and short combination, for example, one long flash followed by a short one, three long flashes followed by three short ones, three short flashes followed by three long ones and three short ones, etc. When above frequencies or frequency combinations flash, the duration can be defined, for example, 3 continued seconds, or 6 continued seconds, etc.

Step S3. The wireless device enters different states or carries out the operations corresponding to the coding ways according to the result data gained by decoding. Wireless device enters different states or takes corresponding operations. The optional states and operations include but not limit to: enable wireless signal of the device. Disable wireless signal of the device. Add the device into a group. Delete the device from a group. Set the current state to a scene. Remove one scene or multiple scenes.

The applied technical solution includes following device and their software:

Flashlight: Flashlight provides a visible lighting, and can flash according to the defined requirements and frequency through controls. The flashlight's flash can be controlled by MCU coding, or controlled by the specially designed hardware, or other ways.

Wireless Intelligent Device: The wireless intelligent device in this invention can run the embedded software. And it needs to comprise a photo sensor component. Other components and functions on the wireless intelligent device have nothing to do with this invention patent innovation, which would not be illustrated and described in this document.

The following explains the operation process involved in the invention patent.

The explanation about this part is only to describe the innovation and interaction operation process of this invention more clearly. It is not a restriction to the actual control process. In the development process, different embodiment plans can be designed based on this, without impact to the innovation of this invention.

As shown in FIG. 1, a general process to achieve assistant control by flashlight is explained as below:

Based on the operation as required, the user starts the defined flash sequence on the flashlight. The flashlight begins to start flashing according to the preset frequency and time.

Software on the wireless device carries out the following operations: Continuously read the photo sensor data.

Determine readouts of the photo sensor, and detect a flash frequency of the flashlight.

Based on the frequency detected, implement the corresponding operation or enter the preset mode.

MCU on the wireless device is SCM with limited resource. To better utilize the limited resource, the operation process is divided into two parts: frequency identification and pattern recognition, and respectively explained.

As shown in FIG. 2, when the wireless device is powered on (Step S101), it continuously reads the data of the photo sensor (Step S102) and calculates the frequency of flash according to data variations of the photo sensor.

In this process, it is required to eliminate an occasional error interference and an interference caused by a constant change of natural light. Meanwhile, determine whether it is an artificial visible light flash in conjunction with analyzing a change proportion and the absolute value change of photo sensor readouts.

Based on the change of photo sensor readouts, calculate out an artificial visible light flash frequency, and then provide this frequency as an input to the pattern recognition processing flow.

If no visible light flash is detected in a period, it is required to inform pattern recognition processing operation flow too.

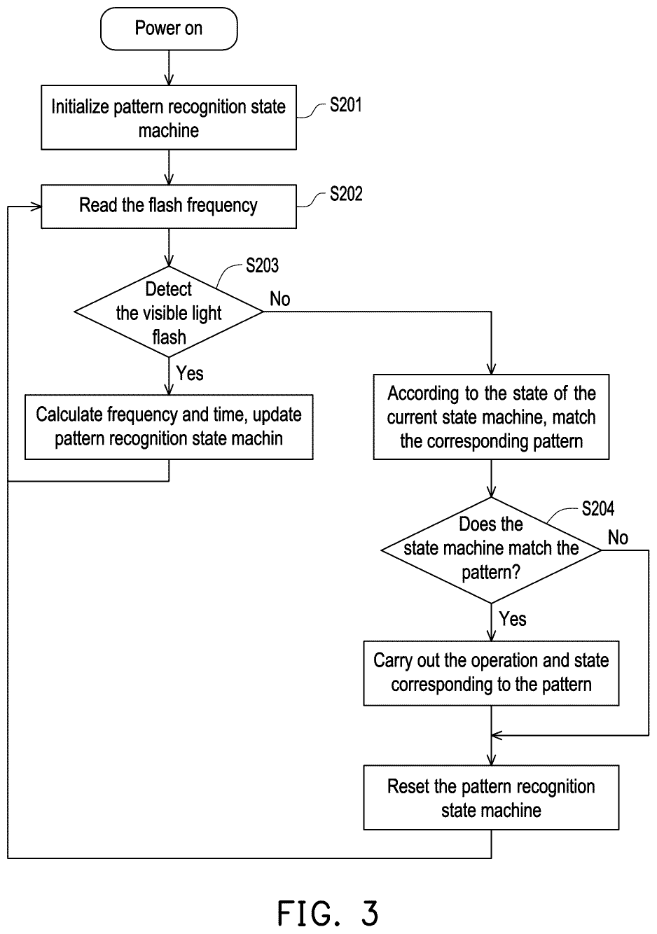

As shown in FIG. 3, during pattern recognition, the state machine is used to meet the recognition requirements of multiple different patterns. (In the practical use and achievement, different solutions can be adopted too.)

Step S201: When it is powered on, the wireless device initializes the pattern recognition state machine.

Step S202: Then, continuously read the frequencies recognized.

Step S203: If no artificial visible light flash frequency is recognized, it indicates a termination of the state machine.

Step S204: If the current state machine matches a preset flash pattern, then carry out the operation corresponding to this pattern (or enter the corresponding state).

Then reset the pattern recognition state machine.

If an artificial visible light flash frequency is recognized, calculating the flash duration of this frequency is required.

If the frequency is the same as the previous, update the duration of this frequency flash, and update the state of this state machine based on this.

If the frequency is different from the previous, update the state of the state machine and record the new flash frequency and duration.

Compared with the common product and solutions in the current market, the visible light frequency pattern recognition control solution offered by this invention has dominant advantages: By using the visible photo sensor of the current controllers to realize it, there is no need to add special sensor or receiving on the device, which efficiently reduces the cost and device complexity.

Frequency pattern recognition with visible light can use the common flashlight, searchlight, and head lamp to operate. Those lamps may already have the flash mode, and can be used directly; Otherwise, they can be easily modified to flash at the specified mode. It is simple, convenient, and feasible.

For light-emitting devices, such as flashlight, it is easy to find, design, and manufacture the product with different powers, different focus or has zoomable lens. It can conveniently meet the demands of different applications, and control light spot range to achieve a precise one-to-one control conveniently.

The common products in the market usually only carry out one single simple operation. This solution can achieve the multiple control demands by means of frequency flash pattern recognition without increasing the cost. This is more flexible and convenient.

Regarding the solution of this invention patent, the control is achieved through remote control without the actual contact, which is more flexible in the actual site application.

According to the technical solution of this invention patent, we select the Bluetooth intelligent lighting controller as wireless device during the implementation.

For the Bluetooth intelligent lighting controller, Telink TLSR8250 Bluetooth chip is adopted as the main chip. This chip integrates the wireless transceiver function of Bluetooth, equipped with a 32M MCU, and has a built-in RAM and flash memory. This chip supports BLE MESH wireless communication technology, and can support up to 255 devices online simultaneously within one network. It is one of the preferred solutions for wireless intelligent device, and is widely used in the market.

The visible photo sensor, motion sensor and lamp control functions are integrated into the Bluetooth intelligent lighting controller. Herein, the visible photo sensor is related to the embodiment of this invention patent. Other functions have nothing do to with this invention patent, so there is neither description in this invention nor impact to the innovation of this invention.

Select the outsourced high-power zoomable flashlight to control operations. This flashlight has the built-in strobe mode with different frequencies, can switch the multiple functions through the button, such as steady on, slow flash at 1 hz, fast flash at 3 Hz, strobe at 5 Hz, etc. All can be combined for use in this embodiment.

In this embodiment, the Bluetooth intelligent lighting controller adopts Telink TLSR8250 Bluetooth chip as the main chip, powered by DC12V, with built-in visible photo sensor motion sensor, and controls lamps through a 0-10V dimming output.

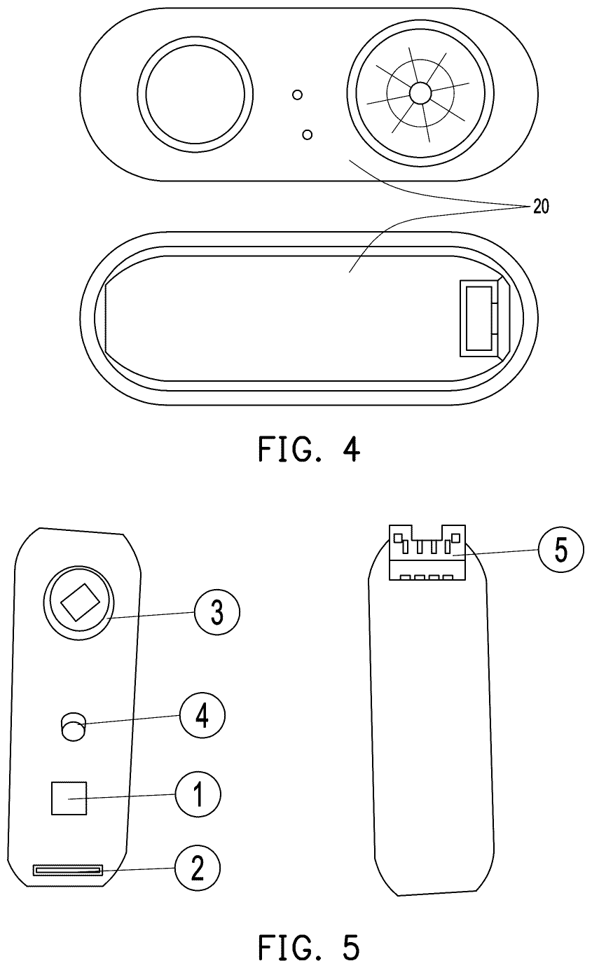

The appearance and PCBA of the controller 20 are as shown in FIG. 4-5.

As shown in FIG. 5, this Bluetooth lamp controller comprises the following components:

Component 1 is the TLSR8250 Bluetooth chip, where Bluetooth transceiver and communication software, intelligent lamp control software are included.

Component 2 is onboard Bluetooth antenna.

Component 3 is passive infrared (PIR) motion sensor.

Component 4 is visible photo sensor.

Component 5 is connector, including DC 12V power supply input and 0-10V dimming output terminals.

Where motion sensor and lamp control function have nothing to do with this invention patent, without impact to the function and effect of this invention, so there is no description in this document.

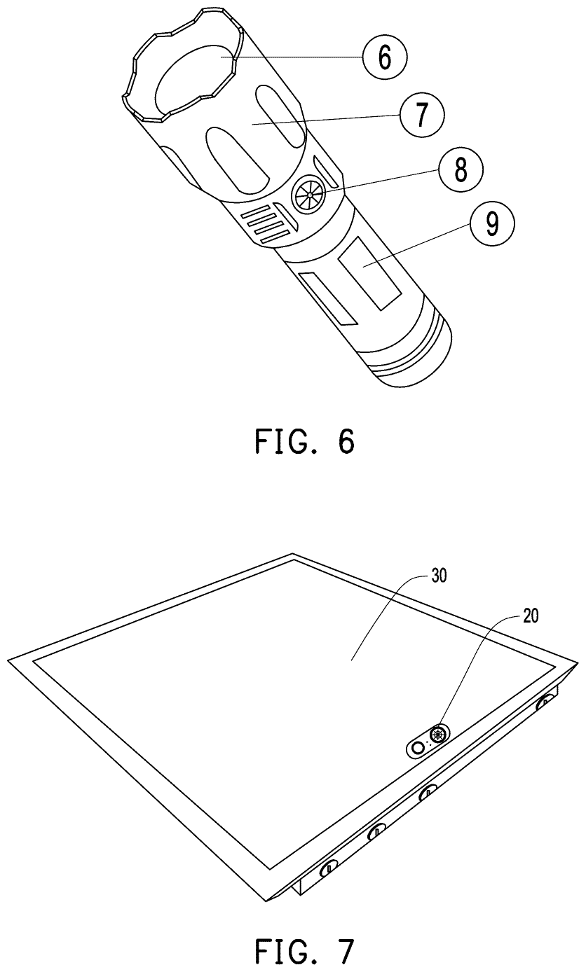

As shown in FIG. 6, flashlight consists of following components:

Component 6 is lighting elements, emitting the visible lights.

Component 7 is a focal length setting ring, adjusting the light spot size. The smaller the light spot is, the stronger the light intensity in unit area is. The bigger the light spot is, the weaker the light intensity in unit area is.

Component 8 is a button, which can be pressed several times to allow the flashlight to flash at different frequencies. This flashlight is a product that can be purchased directly from market, and achieves the flash function with multiple different frequencies through its internal hardware. It can meet a testing demand of this invention solution.

Component 9 is a battery compartment.

In this embodiment, use intelligent lamp 30 and install Bluetooth intelligent lamp controller. Intelligent lamp30 has DC12V auxiliary power supply and 0-10V dimming interface, and has a socket to install the Bluetooth lamp controller, which can work together with the Bluetooth lamp controller, and turn on, off or dim by the Bluetooth lamp controller. As shown in FIG. 7, the specific design and function of the intelligent lamp30 have nothing to do with this invention patent, without impact to the function and effect of this invention, so there is no description in this document.

During the test, set the following flash modes, and operations and patterns corresponding to the Bluetooth intelligent lighting controller.

| | Operations and patterns corresponding |
|---|---|
| | to the Bluetooth intelligent |
| Frequency flash mode | lighting controller |
| Flash for 2 seconds at 3 Hz | Disable wireless transmitting function |
| Flash for 5 seconds at 5 Hz | Enable wireless transmitting function |
| Flash for 3 seconds at 1 Hz + | Restore to factory settings |
| flash for 3 seconds at 3 Hz | |

In the MCU of the Bluetooth intelligent lighting controller, design and write the firmware according to the solution, and configure the flash modes corresponding to above control functions.

With a test, the defined function can be achieved by flashlight illuminating the visible photo sensor of the Bluetooth intelligent lighting controller according to the required frequency flash mode:

When flashlight flashes at 3 Hz frequency and illuminates the sensor for 2 seconds, the Bluetooth intelligent lighting controller disables the wireless transmitting function. The signal from this device can't be scanned on the control device (mobile phone, computer).

When flashlight flashes at 5 Hz frequency and illuminates the sensor for 5 seconds, the Bluetooth intelligent lighting controller enables the wireless transmitting function. The signal from this device can be scanned on the control device (mobile phone, computer).

When flashlight flashes at 1 Hz frequency and illuminates the sensor for 3 seconds, and then flashes at 3 Hz frequency and illuminates the sensor for 3 seconds, the Bluetooth intelligent lighting controller restores to the factory setting state and all controller parameters are restored to the factory settings as well as at an initialized state.

By adjusting the flashlight focal length, light spots in different sizes are formed to illuminate the sensor, which can illuminate the sensor very accurately within a 1˜20 m distance, and achieves the one-to-one control.

The test result indicates that the solution of this invention patent is feasible, and fully meets the design requirements and objectives. It has the excellent market and technical feasibilities.

Another purpose of this invention is to provide a system to control wireless node based on visible light flash pattern recognition. This control system includes

Visible light illuminating controller, used to flash and illuminate the photo sensor on the wireless device by making use of light-emitting devices according to the preset frequency or coding way; Sampling and decoding processor, used for wireless device continuously reading the sample data from photo sensor, and decoding the flash frequency or coding way of the light-emitting devices based on those sampling data;

State operation processor, used for wireless device entering different states or carrying out the operations corresponding to the coding ways based on the result data gained from decoding.

This invention's further technical solution is: the sampling and decoding module as stated also consists of:
Photo sensor reader, used for wireless equipment continuously reading the Photo sensor readouts after power on;
Calculation output processor, used to calculate the artificial visible light flash frequency according to the Photo sensor readout variations and output to the follow-up recognition process flow.

By analyzing the photo sensor readout proportion change or the absolute value exceeding to a certain threshold in the photo sensor reading unit as stated, determine whether it is the artificial visible light flash. If it is, carry out the calculation output processor; if not, return to the photo sensor reader;

The state operation module as stated includes:
Reading and recognition processor, used for wireless device initializing the pattern recognition state machine and continuously reading the flash frequency recognized currently after power on;
Visible light recognition processor, used to determine whether the artificial visible light flash is detected. If it is, calculate the frequency and time, update the pattern recognition state machine and return to reading and recognition processor. If not, match the corresponding patterns according to the state of the current state machine and carry out the state machine determining processor; State machine determining processor, used to determine whether state machine matches a pattern. If it is, the current state machine matches a preset flash pattern, and carry out the operation corresponding to the matched pattern. If not, reset to the pattern recognition state machine and return to the reading and recognition processor;

In case of detecting the artificial visible light flash frequency in the visible light recognition processor as stated, determine whether the flash frequency is the same as the previous while calculating the flash duration of this frequency. If it is, update this frequency flash duration, and update the state of this state machine based on this; if not, update the state of this state machine and record a new flash frequency and duration;

In the visible illuminating processor as stated the preset frequency or coding way includes continued frequency flash or combination frequency flash or those similar to barcodes, morse code; when the said frequency continuously flashes or the combination frequency flashes, duration can be assigned to each frequency.

In the state operation processor as stated, different states or operations corresponding to the coding ways include enabling or disabling the wireless signal of the device, or adding the device to a group or deleting it from a group, or setting the current state to a scene or removing a scene or multiple scenes.

The above-mentioned is just a better embodiment of this invention, and not used as a restriction to this invention. Any modification, equivalent replacement and improvement made in the spirit and principle of this invention shall be included in the protection scope of this invention.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method to control wireless node by visible light flash pattern recognition, comprising following steps:
S1: flashing and illuminating, through a light-emitting device, a photo sensor on a wireless device according to a preset frequency or coding way;
S2: continuously reading, through the wireless device, sample data from the photo sensor, and based on the sample data, decoding a flash frequency or coding way of the light-emitting device;
S3: entering, through the wireless device, different states or carries out operations corresponding to the coding way according to a result data gained by decoding.

2. The method to control wireless node by visible light flash pattern recognition according to claim 1, wherein the step S2 further comprises following steps:
S21: continuously reading, through the wireless equipment, readouts of the photo sensor after power on;
S22: according to readout variations by the photo sensor, calculating an artificial visible light flash frequency and outputting it to a follow-up recognition process flow.

3. The method to control wireless node by visible light flash pattern recognition according to claim 2, wherein
in the step S21, analyzing a proportional change of the readouts of the photo sensor or an absolute value change exceeding to a certain threshold to determine whether it is an artificial visible light flash;
if it is, then carrying out the step S22;
if not, returning to the step S21.

4. The method to control wireless node by visible light flash pattern recognition according to claim 3, wherein the step S3 comprises following steps:
S31: powering on the wireless device to initialize a pattern recognition state machine and continuously reading out the currently read by the photo sensor;
S32: determining whether it is the artificial visible light flash;
if it is, calculating frequency and time and updating the pattern recognition state machine, then returning to the step S31;
if not, matching a corresponding pattern in accordance with a condition of the pattern recognition state machine and carrying out a next step;
S33: determining whether the pattern recognition state machine matches any preset patten;
if yes, carrying out operations corresponding to a matched pattern or entering a corresponding state;
if not, resetting to the pattern recognition state machine and returning to the step S31.

5. The method to control wireless node by visible light flash pattern recognition according to claim 4, wherein
in the step S32, in case of detecting the artificial visible light flash frequency, determining whether the flash frequency is the same as a previous while calculating a flash duration of the flash frequency;
if it is, updating the flash duration of the flash frequency, and updating a state of the pattern recognition state machine based on the flash duration;
if not, updating the state of the pattern recognition state machine and recording a new flash frequency and duration.

6. The method to control wireless node by visible light flash pattern recognition according to claim 5, wherein in the step S1 the preset frequency or coding way comprises continued frequency flash, combination frequency flash, barcodes, or morse code; when flashing with the continued frequency flash or the combination frequency flash, a duration is assigned to each frequency.

7. The method to control wireless node by visible light flash pattern recognition according to claim 6, wherein in the step S3 the different states or the operations corresponding to the coding ways comprise enabling or disabling a wireless signal of the wireless device, or adding the wireless device to a group or deleting the wireless device from a group, or setting a current state to a scene or removing a scene or multiple scenes.

8. A system to control wireless node by visible light flash pattern recognition, comprising:
a visible light illuminating controller, used to flash and illuminate a photo sensor on a wireless device by making use of light-emitting devices according to a preset frequency or coding way;
a sampling and decoding processor, used for continuously reading, through the wireless device, sample data from the photo sensor, and decoding a flash frequency or coding way of the light-emitting devices based on the sampling data;
a state operation processor, used for entering, through the wireless device, different states or carrying out operations corresponding to the coding way based on a result data gained from decoding.

9. The system to control wireless node by visible light flash pattern recognition according to claim 8, wherein the sampling and decoding processor comprises:
a photo sensor reader, used for continuously reading, through the wireless device, readouts of the photo sensor after power on;
a calculation output controller, used to calculate an artificial visible light flash frequency according to readout variations of the photo sensor and output to a follow-up recognition process flow.

10. The system to control wireless node by visible light flash pattern recognition according to claim 9, wherein
by analyzing the photo sensor readout proportion change or an absolute value exceeding to a certain threshold in the photo sensor reader as stated, whether it is an artificial visible light flash is determined; if it is, a process of the calculation output controller is carried out; if not, a process is returned to the photo sensor reader;
the state operation processor comprises:
a reading and recognition processor, used for initializing, through the wireless device, a pattern recognition state machine and continuously reading the flash frequency recognized currently after power on;
a visible light recognition processor, used to determine whether the artificial visible light flash is detected; if it is, the visible light recognition processor calculates the frequency and time, and updates the pattern recognition state machine, and a process returns to the reading and recognition processor; if not, the visible light recognition processor matches corresponding patterns according to a current state of the pattern recognition state machine and carries out the state machine determining processor;
a state machine determining processor, used to determine whether the pattern recognition state machine matches a pattern; if it is, the current state of the pattern recognition state machine matches a preset flash pattern, and an operation corresponding to a matched pattern is carried out; if not, the state machine determining processor resets to the pattern recognition state machine and a process is returned to the reading and recognition processor; wherein
in case of detecting the artificial visible light flash frequency in the visible light recognition processor as stated, whether the flash frequency is the same as a previous is determined while calculating a flash duration of the flash frequency; if it is, the flash duration of the flash frequency is updated, and a state of the pattern recognition state machine is updated based on the flash duration; if not, the state of the pattern recognition state machine is updated and a new flash frequency and duration are recorded;
the preset frequency or coding way configured for the visible illuminating controller comprises continued frequency flash, combination frequency flash, barcodes, or morse code; when flashing with the continued frequency flash or the combination frequency flash, a duration is assigned to each frequency;
the different states or operations corresponding to the coding ways configured for the state operation processor comprise enabling or disabling a wireless signal of the wireless device, or adding the processor device to a group or deleting the wireless device from a group, or setting a current state to a scene or removing a scene or multiple scenes.
